(19) United States
(12) Patent Application Publication
(10) Pub. No.: US 2013/0332316 A1
(43) Pub. Date: Dec. 12, 2013

(54) Systems and Methods for Facilitating Business to Business Commerce

(71) Applicant: The Procter & Gamble Company, Cincinnati, OH (US)

(72) Inventors: Frank Paul, Cincinnati, OH (US); Seshagiri Rao Tripurana, Mason, OH (US); Marc Grau Perez, Cincinnati, OH (US); Lalgudi Natarajan Prasad, Mason, OH (US)

(21) Appl. No.: 13/906,733

(22) Filed: May 31, 2013

Related U.S. Application Data
(60) Provisional application No. 61/657,193, filed on Jun. 8, 2012.

(51) Int. Cl. G06Q 30/06

(52) U.S. Cl. CPC G06Q 30/0633
USPC 705/26.62; 705/26.8

(57) ABSTRACT

Included are embodiments for facilitating business to business commerce. Some embodiments include registering a supplier account for a business supplier on an online marketplace, wherein registering the account comprises receiving a catalog of items provided by the supplier, registering a purchaser account for a business purchaser on the online marketplace, wherein the business purchaser represents a business entity, and providing a user interface to facilitate purchase of the item by the business purchaser from the business supplier. Similarly, some embodiments include receiving an indication from the business purchaser of a purchase of the item and facilitating exchange of the item for a predetermined price between the business purchaser and the business supplier.

### FIELD OF THE INVENTION

The present application relates generally to systems and methods for facilitating business to business commerce and specifically to providing an online marketplace for a business to secure and/or purchase goods and services in a business to business transaction.

### BACKGROUND OF THE INVENTION

While the business to customer online marketplace has found widespread acceptance, many business to business transactions are often subject to various hurdles in automation, communication, and other features. Additionally, many business to business transactions are subject to corporate regulations, where compliance is a prerequisite for completing the translation.

### SUMMARY OF THE INVENTION

Included are embodiments for facilitating business to business commerce. Some embodiments include registering a supplier account for a business supplier on an online marketplace, wherein registering the account comprises receiving a catalog of items provided by the supplier, registering a purchaser account for a business purchaser on the online marketplace, wherein the business purchaser represents a business entity, and providing a user interface to facilitate purchase of the item by the business purchaser from the business supplier. Similarly, some embodiments include receiving an indication from the business purchaser of a purchase of the item and facilitating exchange of the item for a predetermined price between the business purchaser and the business supplier.

Also included are embodiments of a system. Some embodiments of the system include a memory component that stores logic that, when executed by the system, causes the system to register a supplier account for a business supplier on an online marketplace, wherein registering the account comprises receiving a catalog of items provided by the supplier, register a purchaser account for a business purchaser on the online marketplace, wherein the business purchaser represents a business entity, and provide a user interface to facilitate purchase of the item by the business purchaser from the business supplier. In some embodiments, the logic causes the system to receive an indication from the business purchaser of a purchase of the item and facilitate exchange of the item for a predetermined price between the business purchaser and the business supplier.

Also included are embodiments of a non-transitory computer-readable medium. Some embodiments of the non-transitory computer-readable medium include logic that, when executed by a computing device, causes the computing device to register a supplier account for a business supplier on an online marketplace, wherein registering the account comprises receiving a catalog of items provided by the supplier, register a purchaser account for a business purchaser on the online marketplace, wherein the business purchaser represents a business entity, and provide a user interface to facilitate purchase of the item by the business purchaser from the business supplier. In some embodiments, the logic causes the computing device to receive an indication from the business purchaser of a purchase of the item and facilitate exchange of the item for a predetermined price between the business purchaser and the business supplier.

### BRIEF DESCRIPTION OF THE DRAWINGS

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate various embodiments described herein, and together with the description serve to explain the principles and operations of the claimed subject matter.

FIG. 1 depicts a computing environment for facilitating business to business commerce, according to embodiment disclosed herein;

FIG. 2 depicts a remote computing device for facilitating business to business commerce, according to embodiments disclosed herein;

FIG. 3 depicts a user interface that may be provided for a business user to locate a product and/or service, according to embodiments disclosed herein;

FIG. 4 depicts a user interface for providing a plurality of products and/or services to a business user in response to a keyword search, according to embodiments disclosed herein;

FIG. 5 depicts a user interface for providing a selected product to a business user, according to embodiments disclosed herein;

FIG. 6 depicts a user interface for providing catalog options to a product supplier, according to embodiments disclosed herein;

FIG. 7 depicts a user interface for providing marketplace competition data to a business supplier, according to embodiments disclosed herein;

FIG. 8 depicts a user interface for providing communication options to a business supplier, according to embodiments disclosed herein;

FIG. 9 depicts a user interface for providing a business to business marketplace to a business supplier, according to embodiments disclosed herein;

FIG. 10 depicts a user interface for registering an account manager for a business supplier, according to embodiments disclosed herein;

FIG. 11 depicts a user interface for providing a plurality of options to a business supplier, according to embodiments disclosed herein;

FIG. 12 depicts a user interface for providing a business supplier classification, according to embodiments disclosed herein;

FIG. 13 depicts a user interface for providing product supplier options, according to embodiments disclosed herein;

FIG. 14 depicts a user interface for providing a simulation toolkit to a business supplier, according to embodiments disclosed herein; and

FIG. 15 depicts a flowchart for facilitating business to business commerce, according to embodiments disclosed herein.

### DETAILED DESCRIPTION OF THE INVENTION

Embodiments disclosed herein include systems and methods for facilitating business to business commerce. As an example, embodiments disclosed herein create new capabilities to facilitate transactions, ensure compliance with applicable regulations, and thus maximize value. Specifically, embodiments disclosed herein provide a transparent marketplace to connect all corporate employees with the desired suppliers, enabling them to buy the products and/or services the corporation desires in an efficient manner. Thus, embodiments disclosed herein expand the digitization of the entire process from source to pay that delivers step change in the user experience, creating incremental cost savings, employee productivity gains and new revenue streams.

As a result, embodiments disclosed herein deliver a one search functionality and shopping experience to corporate employees, where products and/or services can be compared across multiple suppliers. Additionally, embodiments provide one or more interfaces for browsing through ratings and reviews, locating service providers, and paying for the selected products and/or services. Because embodiments disclosed herein eliminate many procurement processes such as purchase orders, goods receipts, service confirmations, and/or invoices, a more efficient procurement process is provided.

Additionally, embodiments disclosed herein enable sourcing buyers to manage markets versus individual orders. Buyers can leverage competition to generate additional savings and productivity gains; designate low value order strategies, project sourcing partner organizations, and strategic sourcing engagement rules. The transparent marketplace will show preferred suppliers' offerings, capabilities, attributes and their performance indicators. Driving more spend to core suppliers will deliver additional value.

Suppliers also benefit from the online marketplace. Specifically, business suppliers are able to reach more users, thus expanding their market and increasing their sales. Business suppliers may also receive real-time feedback directly from the users, which will ensure that suppliers optimize their business per each target audience. Business suppliers can also choose to receive analysis on the overall market standings, which will deliver further competitive savings.

Accordingly, embodiments disclosed herein include checkout capabilities, including virtual ProCard, intelligent order, tracking and accounting, payment gateway, and peer to peer integration. With regard to the search and user interface, embodiments disclosed herein include a single search and entry point, an alternative procurement selection, and interactive feedback. With regard to marketplace management, embodiments disclosed herein provide a communication gateway between suppliers, users, and purchasers, a marketplace on boarding supplier portfolio and services register, digitization of goods content, supplier enablement, and a sourcing connection.

Embodiments also include services supplier discovery. This may include service procurement guide for collaborating from business need to execution, knowledge management, and seamless integration of platforms. Governance and risk management is also provided and includes compliance, policy engagement, risk assessment, information security, governance, and privacy controls. Business intelligence is also provided and includes personalization and recommendation, market intelligence, user intelligence, internal business insights, post decision analysis, marketplace performance, and market optimization. Other features are also provided in more detail below and depicted in the Appendix.

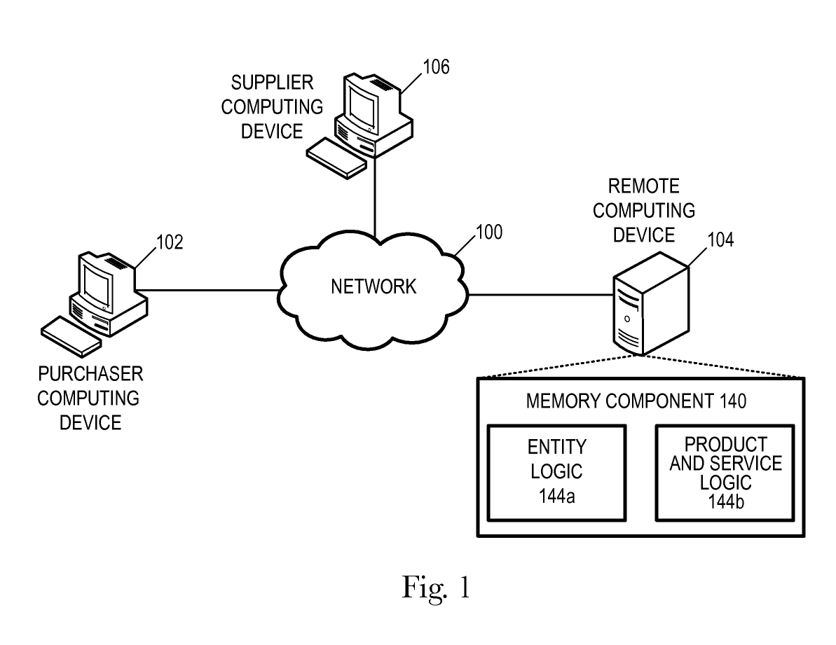

Referring now to the drawings, FIG. 1 depicts a computing environment for facilitating business to business commerce, according to embodiments disclosed herein. As illustrated, a network 100 may be coupled to a purchaser computing device 102, a remote computing device 104, and a supplier computing device 106. The network 100 may include any wide area and/or local area network, such as the internet, a mobile communications network, a satellite network, a public service telephone network (PSTN) and/or other network for facilitating communication between numerous devices.

Accordingly, the purchaser computing device 102 may include a personal computer, laptop computer, laptop, mobile computing device, mobile communications device, server, database, and/or other computing device for implementing the functionality described herein. Regardless, the purchaser computing device 102 may provide at least a portion of the user interfaces described herein for allowing a business user to locate and acquire business products and/or services. Similarly, the remote computing device 104 may include any of the devices described with regard to the user computing devices and may be configured for generating the user interfaces and/or facilitating the purchase between the business user and the business supplier. The supplier computing device 106 may be configured as any of the devices described above and may be configured for providing interfaces for the business supplier to register an account and/or provide business products and/or services to the business user.

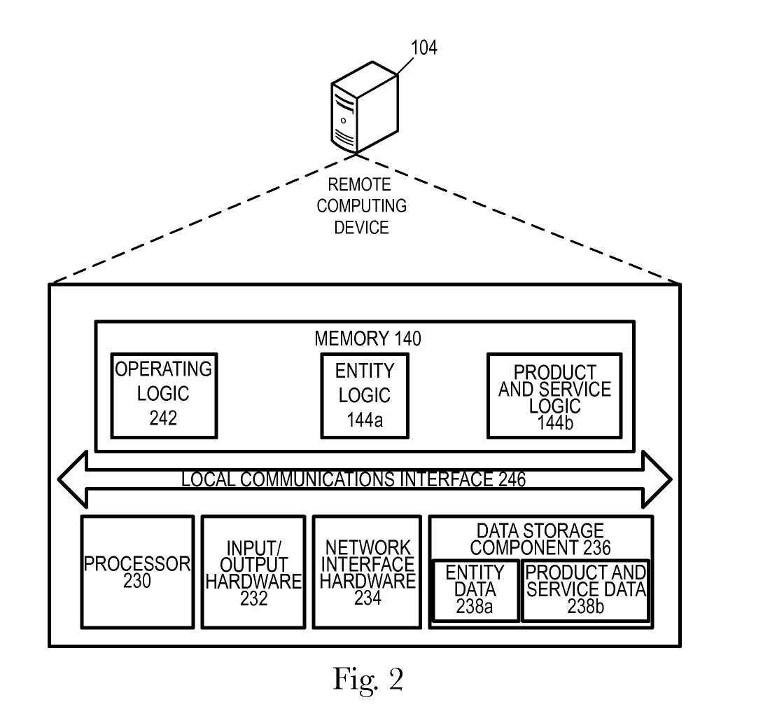

FIG. 2 depicts a remote computing device 104 for facilitating business to business commerce, according to embodiments disclosed herein. In the illustrated embodiment, the remote computing device 104 includes a processor 230, input/output hardware 232, network interface hardware 234, a data storage component 236 (which stores entity data 238a and product and service data 238b), and the memory component 140. The memory component 140 may be configured as volatile and/or nonvolatile memory and, as such, may include random access memory (including SRAM, DRAM, and/or other types of RAM), flash memory, registers, compact discs (CD), digital versatile discs (DVD), and/or other types of non-transitory computer-readable mediums. Depending on the particular embodiment, these non-transitory computer-readable mediums may reside within the remote computing device 104 and/or external to the remote computing device 104.

Additionally, the memory component 140 may be configured to store operating logic 242, the entity logic 144a, and the product and service logic 144b, each of which may be embodied as a computer program, firmware, and/or hardware, as an example. A local communications interface 246 is also included in FIG. 2 and may be implemented as a bus or other interface to facilitate communication among the components of the remote computing device 104.

The processor 230 may include any processing component operable to receive and execute instructions (such as from the data storage component 236 and/or memory component 140). The input/output hardware 232 may include and/or be configured to interface with a monitor, keyboard, mouse, printer, camera, microphone, speaker, and/or other device for receiving, sending, and/or presenting data. The network interface hardware 234 may include and/or be configured for communicating with any wired or wireless networking hardware, a satellite, an antenna, a modem, LAN port, wireless fidelity (Wi-Fi) card, WiMax card, mobile communications hardware, and/or other hardware for communicating with other networks and/or devices. From this connection, communication may be facilitated between the remote computing device 104 and other computing devices.

Similarly, it should be understood that the data storage component 236 may reside local to and/or remote from the remote computing device 104 and may be configured to store one or more pieces of data for access by the remote computing device 104 and/or other components. In some embodiments, the data storage component 236 may be located remotely from the remote computing device 104 and thus accessible via the network 100. In some embodiments however, the data storage component 236 may merely be a peripheral device, but external to the remote computing device 104.

Included in the memory component 140 are the operating logic 242, the entity logic 144a and the product and service logic 144b. The operating logic 242 may include an operating system and/or other software for managing components of the remote computing device 104. Similarly, the entity logic 144a may be configured to cause the remote computing device 104 to connect business purchasers with business suppliers in an electronic marketplace environment. Similarly, the product and service logic 144b may be configured to cause the remote computing device 104 to determine products and/or services that are provided by the business suppliers and desired by the business purchasers.

It should be understood that the components illustrated in FIG. 2 are merely exemplary and are not intended to limit the scope of this disclosure. While the components in FIG. 2 are illustrated as residing within the remote computing device 104, this is merely an example. In some embodiments, one or more of the components may reside external to the remote computing device 104. It should also be understood that, while the remote computing device 104 in FIGS. 1 and 2 is illustrated as a single system, this is also merely an example. In some embodiments, the content providing functionality is implemented separately from the advertisement functionality, which may be implemented with separate hardware, software, and/or firmware.

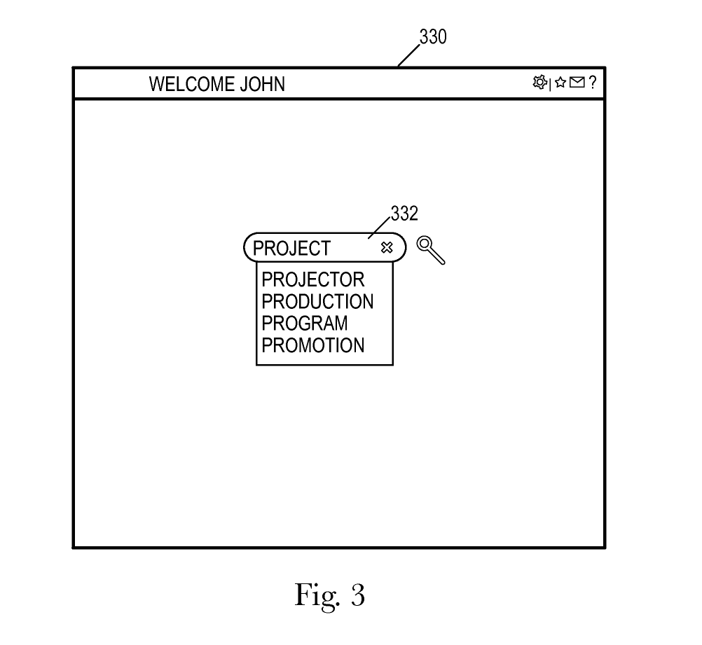

FIG. 3 depicts a user interface 330 that may be provided for a business user to locate a product and/or service, according to embodiments disclosed herein. As illustrated, a business purchaser may access the user interface 330 and enter a search term in the search portion 332. In response to receiving the search term, the remote computing device 104 may search for products and/or services associated with the received search term.

In some embodiments, the search may be performed in the online marketplace. However, in some embodiments, a first search may be performed external to the online marketplace. As an example, if the online marketplace does not carry the searched item, the remote computing device may perform a second search external to the online marketplace. Similarly, if the item is located on the online marketplace, additional searching may be performed to determine whether the item is offered external to the online marketplace for a lower price. If the lower price compared to the price of the item in the online marketplace exceeds a predetermined threshold difference (e.g., if the item is offered for greater than 2% less than on the online marketplace), the item may be provided to the user via the supplier offering the lower price.

Similarly, in some embodiments, searching may be dictated by the location of the purchaser, supplier, and/or item. As an example, if the item is associated with a country that has a trade embargo with a country associated with the purchaser, the item may be removed from the search. Similarly, searching may be limited based on geographic location of the business purchaser and/or the business supplier.

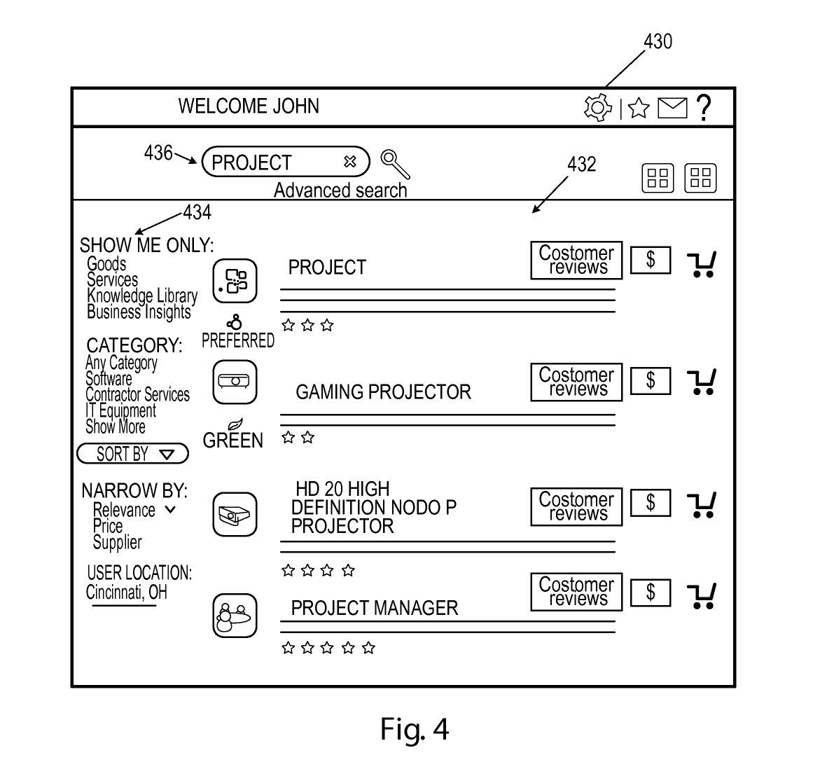

FIG. 4 depicts a user interface 430 for providing a plurality of products and/or services to a business user in response to a keyword search, according to embodiments disclosed herein. In response to performing a search for products and/or services associated with the received search term, the remote computing device 104 may provide the associated products and/or services. Specifically, the products and/or services may be provided by business suppliers, such as via the supplier computing device 106. The products may then be provided in a product section 432 of the user interface 430. The user interface 430 includes a filtering and sorting section 434 and a search area 436. The filtering and sorting section 434 may include options for filtering the search and/or for sorting the results. The search area 436 provides an area for the user to alter the search to more easily locate the desired good and/or service.

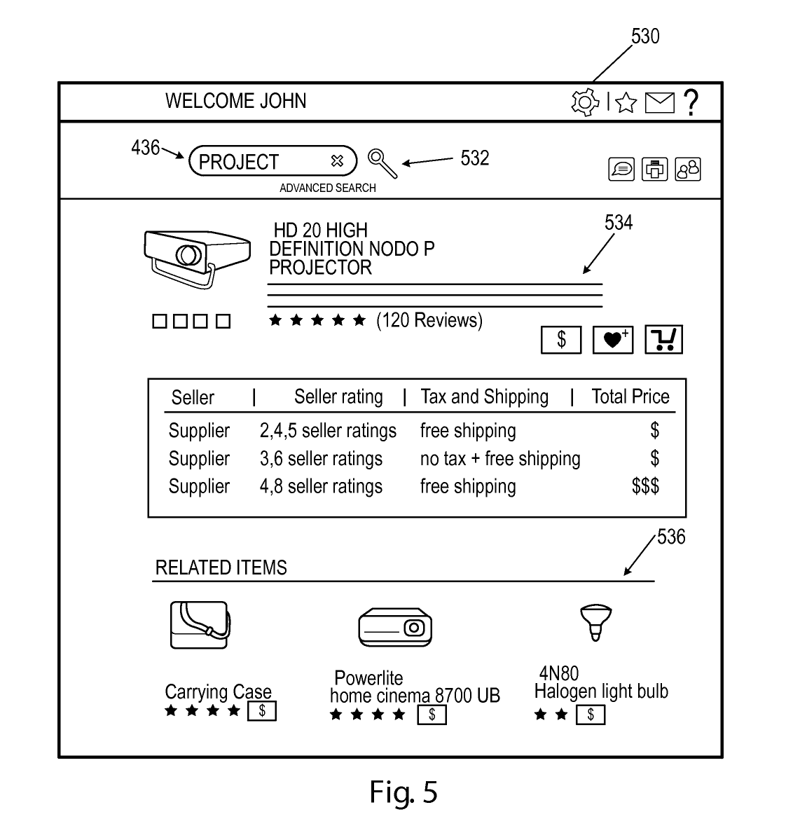

FIG. 5 depicts a user interface 530 for providing a selected product to a business user, according to embodiments disclosed herein. In response to selection of one of the products and/or services from the user interface 430 from FIG. 4, the user interface 530 may be provided. Included in the user interface 530 are a search option 532, a product area 534, and a related items area 536. The search area 532 includes an area for the user to begin a new search and/or edit the existing search. The product area 534 may include details on the selected product. Options for viewing the business supplier that provides the product, options for purchasing the product, options for viewing user ratings, and/or other options may be provided in the product area 534. The related products area 556 may provide other products and/or services from the same supplier and/or simply related to the product type as is being provided in the product area 534.

As illustrated with regard to FIGS. 3-5, embodiments disclosed herein provide a single entry point for procurement. The entry point and search will also integrate with a risk management module to filter out and/or highlight results based on business function or enterprise requirements. Embodiments may also provide digital service via a virtual procurement agent. The virtual procurement agent may be configured to deliver a web-based support function that can virtually guide users to the correct solution. This capability not only looks at the shopping experience, but provides support, such as with error messages, searches for training documentation, etc.

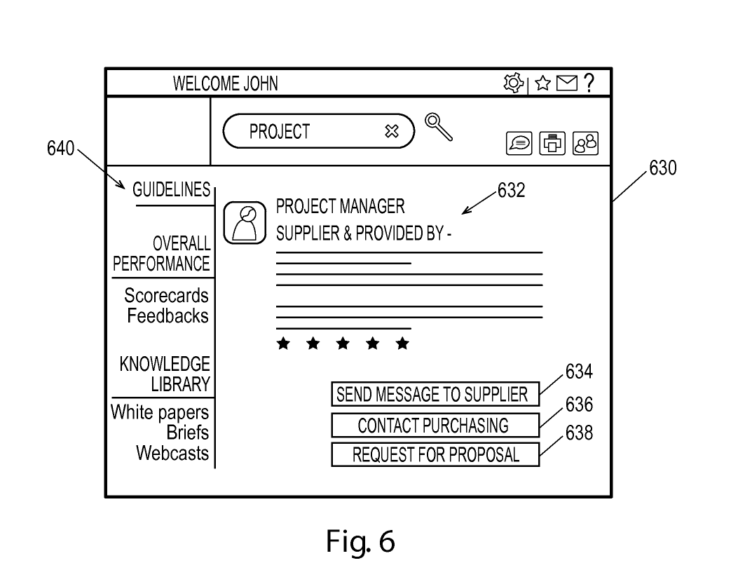

FIG. 6 depicts a user interface 630 for providing catalog options to a product supplier, according to embodiments disclosed herein. As illustrated, the user interface 630 may include a messaging area 632 for providing comments to the business supplier. Specifically, the messaging area 632 includes a ranking option and a plurality of options for contacting the supplier. Specifically, a contact supplier option 634, a contact purchasing option 636, and a request for proposal option 638 are provided. The contact supplier option 634 may provide the business purchaser with a mechanism for sending a direct message to the business supplier. The contact purchaser option 636 provides the business purchaser with an option to send a direct message to the purchasing department of the online marketplace and/or the business supplier. The request for proposal option 638 may provide the business purchaser with a mechanism for request a proposal for purchase to the business supplier. A sidebar options area 640 is also provided for providing guidelines, overall performance scorecards, feedbacks, and a knowledge library.

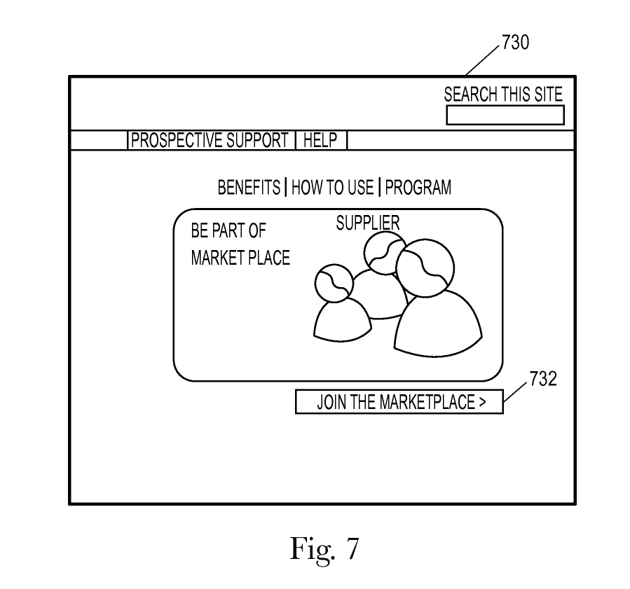

FIG. 7 depicts a user interface 730 for providing marketplace competition data to a business supplier, according to embodiments disclosed herein. As illustrated in user interface 730, a business supplier may join the online marketplace for providing products and/or services to business purchasers. As an example, a business such as ACME Inc. may have multiple divisions, but may register as a business purchaser for all (or some of those divisions). Any user who properly authenticates under that business purchaser account may purchase products and/or services under that account. Accordingly, a business supplier, such as Law Firm LLP may provide legal services to businesses. Accordingly, the business supplier may select the join option 732 to register to begin providing products and/or services according to embodiments disclosed herein.

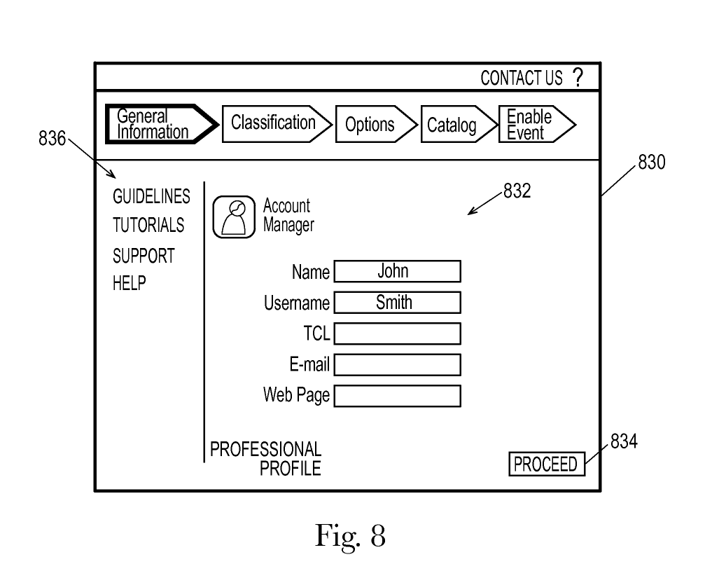

FIG. 8 depicts a user interface 830 for providing communication options to a business supplier, according to embodiments disclosed herein. In response to selection of the join option 732 from FIG. 7, the user interface 830 may be provided. The user interface 830 includes an account setup area 832 for receiving information about an account manager. In response to inputting the requested information, the user may select a proceed option 834 to proceed to the next user interface. Also included in the user interface 830 is a sidebar options section 836. The sidebar options section 836 may include one more options for receiving support, help, guidelines, tutorials, and/or other information.

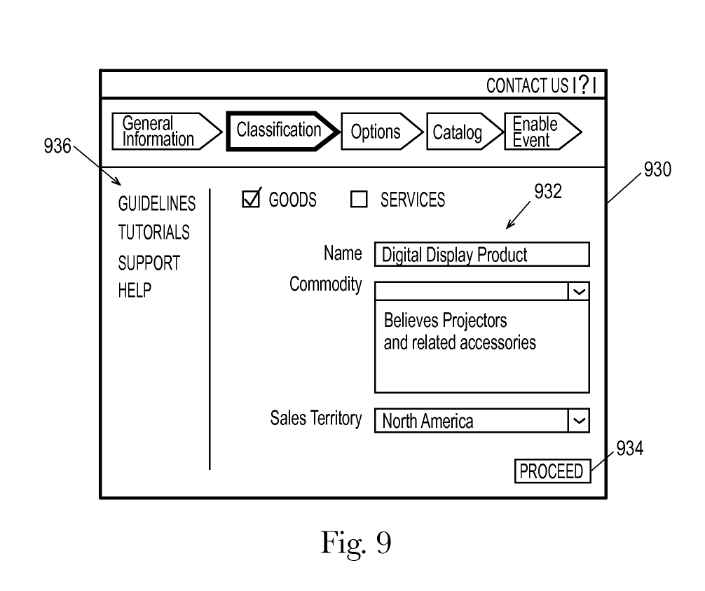

FIG. 9 depicts a user interface 930 for providing a business to business marketplace to a business supplier, according to embodiments disclosed herein. In response to selection of the proceed option 834 from FIG. 8, the user interface 930 may be provided. Specifically, the user interface 930 includes a classification section 932 for the business supplier to indicate whether the business supplier will provide products and/or services, the industry that the business supplier works, the commodity the supplier is offering, the sales territory in which the supplier operates, and/or other information. In response to inputting the requested information, the business supplier may select the proceed option 934 to proceed to the next user interface. Also included is a sidebar option section 936, which includes a plurality of options, such as guidelines, tutorials, support, help, and/or other options.

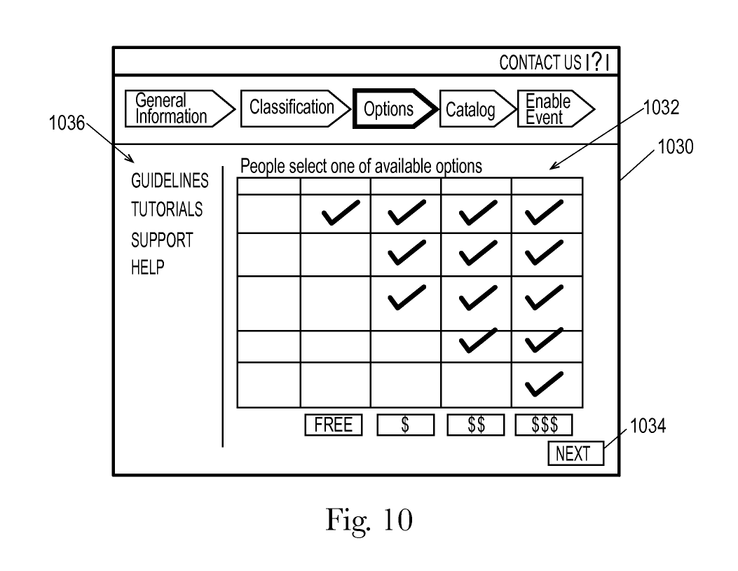

FIG. 10 depicts a user interface 1030 for registering an account manager for a business supplier, according to embodiments disclosed herein. In response to selection of the proceed option 934 from FIG. 9, the user interface 1030 may be provided. The user interface 1030 may include an options section 1032 for the business supplier to determine one or more options that will be included in the business supplier account. As an example, the business supplier may select which marketplace tools, analytic information, and/or other options that may be associated with the business supplier account. Each option may be associated with extra charges to the business supplier. Upon selecting the desired options, the user may select the next option 1034 for proceeding to the next user interface. Also included is a sidebar options section 1036, which may include guidelines, tutorials, support, help, and/or other options.

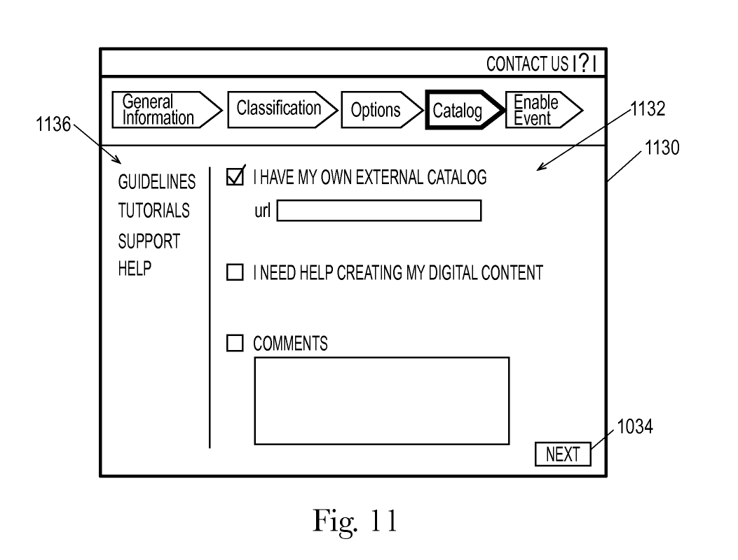

FIG. 11 depicts a user interface 1130 for providing a plurality of options to a business supplier, according to embodiments disclosed herein. As illustrated, the user interface 1130 may include a catalog area 1132 for providing product and/or service information. As an example, the business supplier will advertise on the online marketplace. If the business supplier already has a website or other external catalog of products and/or services, the business supplier may enter a web address associated with that eternal catalog. If the business supplier does not have an external catalog, the business supplier can select an option indicating that assistance is requested in creating the online catalog. In response to inputting the desired information, the business supplier may select the next option 1134 for proceeding to the next user interface. Additionally included is a sidebar options section 1136 for providing guidelines, tutorials, support, help, and/or other information.

Once the business supplier account has been created, products and/or services associated with that account may be provided. Specifically, as illustrated in FIGS. 3-6, one or more products from the business supplier may be provided to the business purchaser. Additionally, the business supplier may be provided with one or more account management user interfaces for managing the account, viewing analytics, and/or performing other actions.

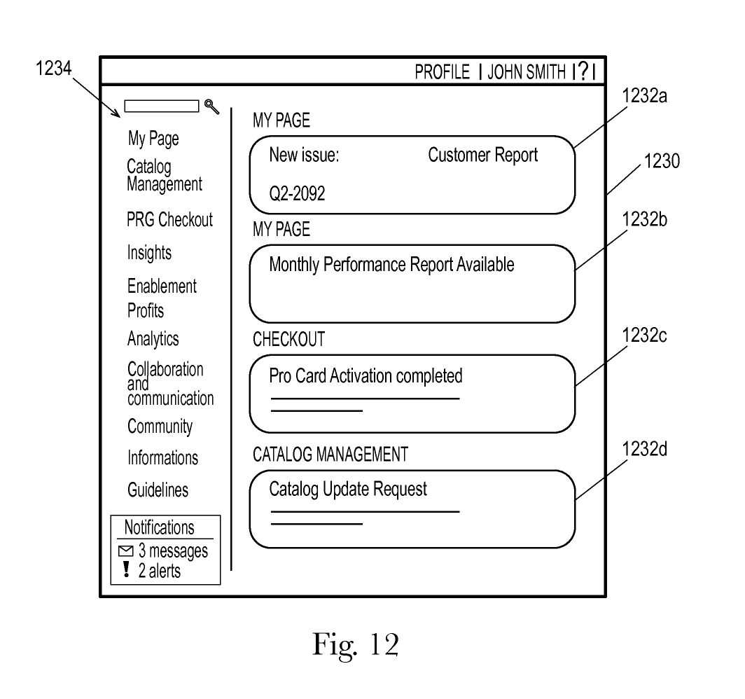

FIG. 12 depicts a user interface 1230 for providing a business supplier classification, according to embodiments disclosed herein. As illustrated, the user interface 1230 includes a plurality of reports associated with the supplier account. Specifically, the user interface 1230 includes a Q2 report option 1232a, a monthly performance report option 1232b, a card activation option 1232c, and a catalog update request option 1232d. Also included is a sidebar option section 1234, which includes options for catalog management, checkout, insights, enablement process, analytics, collaboration and communication, community guidelines, and/or other options.

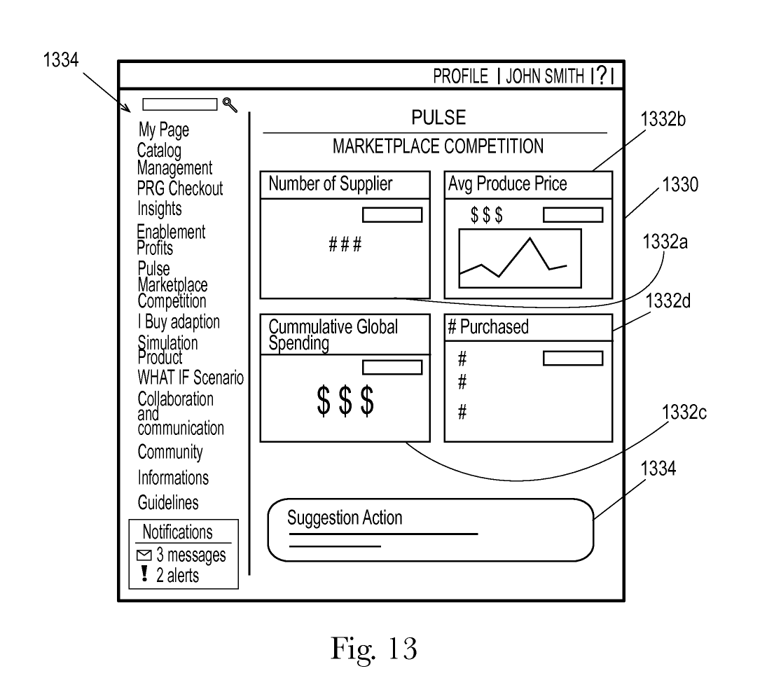

FIG. 13 depicts a user interface 1330 for providing product supplier options, according to embodiments disclosed herein. As illustrated, the user interface 1330 includes an analytics section, which includes a supplier section 1332a, an average product price section 1332b, a cumulative global spending section 1332c, and a number purchased section 1332d. The supplier section 1332a may provide the number of other suppliers with whom the business supplier is currently competing. The average product price section 1332b provides the average price paid by various business purchasers for one or more goods. The cumulative global spending section 1332c may provide the dollar amount that has been spent with the business supplier and/or throughout the marketplace as a whole. The number purchased section 1332d may provide the number of items that have been sold for each product offered by the business supplier.

Also included are a suggested action section 1334 and a sidebar option section 1336. The suggested action section 1334 may provide the business supplier with a text prompt for indicating suggested actions that may be taken in the future. The sidebar option section 1336 may provide options for catalog management, checkout, insights, enablement process, pulse marketplace competition, collaboration and communication, community guidelines, and/or other options. A messaging option may also be provided for facilitating a message between the business supplier and the business purchaser.

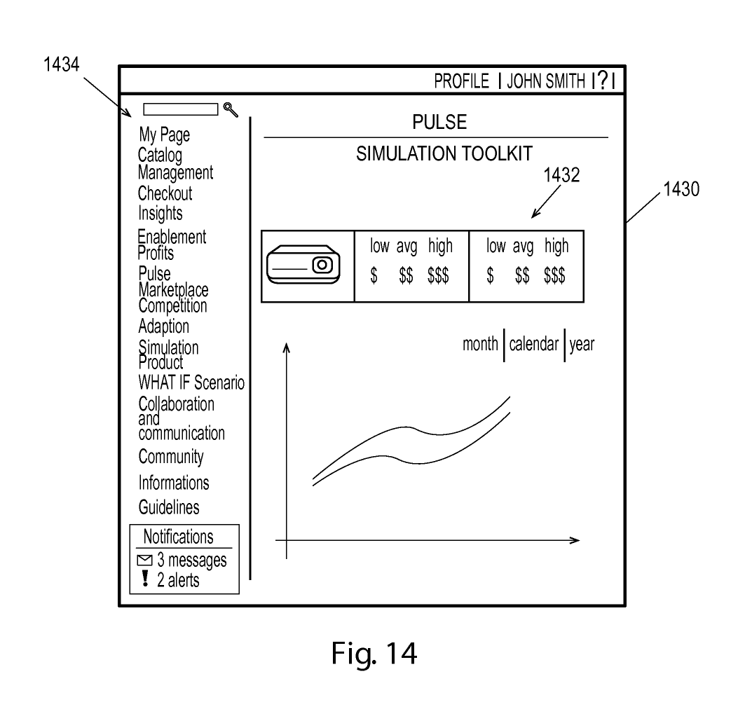

FIG. 14 depicts a user interface 1430 for providing a simulation toolkit to a business supplier, according to embodiments disclosed herein. As illustrated, the user interface 1430 may include a simulation toolkit area that provides the business supplier with options regarding sales of a particular product and/or service. Also included is a sidebar option area for providing options related to catalog management, checkout, insights, enablement process, competition, and/or other options.

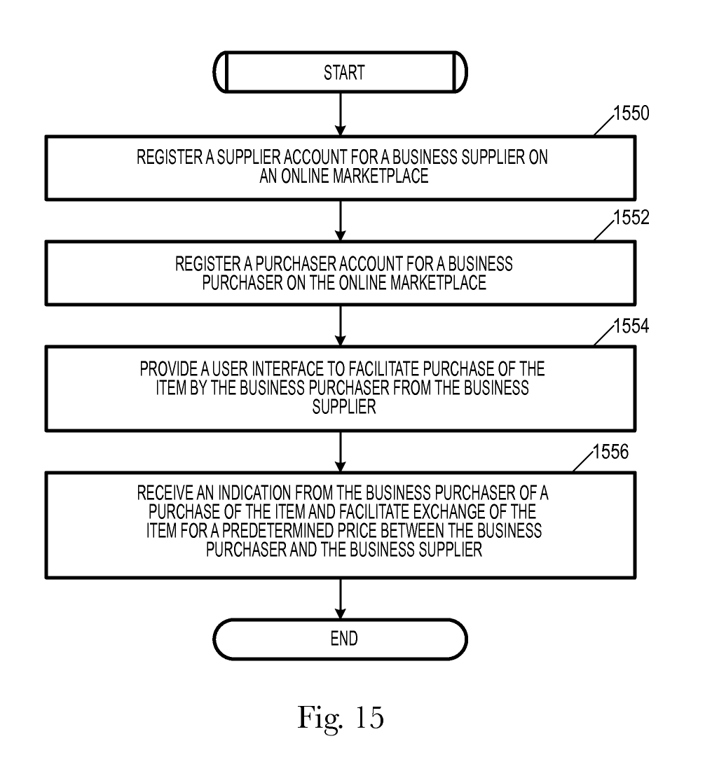

FIG. 15 depicts a flowchart for facilitating business to business commerce, according to embodiments disclosed herein. As illustrated in block 1550, a supplier account for a business supplier may be registered on an online marketplace. In some embodiments, registering the account includes receiving a catalog of items provided by the supplier. In block 1552, a purchaser account may be registered for a business purchaser on the online marketplace, where the business purchaser represents a business entity. In block 1554 a user interface may be provided to facilitate purchase of the item by the business purchaser from the business supplier. In block 1556, an indication may be received from the business purchaser of a purchase of the item and facilitating exchange of the item for a predetermined price between the business purchaser and the business supplier. The predetermined price may include any negotiated or non-negotiated price.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be understood to those skilled in the art that various other changes and modifications can be made without departing from the spirit and scope of the invention. It is therefore intended to cover in the appended claims all such changes and modifications that are within the scope of this invention.

What is claimed is:

1. A system for facilitating business to business commerce comprising:
a memory component that stores logic that, when executed by the system, causes the system to perform at least the following:
register a supplier account for a business supplier on an online marketplace, wherein registering the supplier account comprises receiving a catalog of items provided by the business supplier;
register a purchaser account for a business purchaser on the online marketplace, wherein the business purchaser represents a business entity;
provide a user interface to facilitate purchase of the item by the business purchaser from the business supplier;
receive an indication from the business purchaser of a purchase of the item; and
facilitate exchange of the item for a predetermined price between the business purchaser and the business supplier.

2. The system of claim 1, wherein the item comprises at least one of the following: a product and a service.

3. The system of claim 1, wherein the logic further causes the system to provide a messaging option to facilitate a message between the business purchaser and the business supplier.

4. The system of claim 3, wherein the messaging option comprises an option for performing at least one of the following: a direct message from the business purchaser, a direct message from the business purchaser to a purchasing department, and a request for proposal from the business purchaser to the business supplier.

5. The system of claim 1, wherein the logic further causes the system to provide analytic information regarding the item.

6. The system of claim 1, wherein the logic further causes the system to provide an option for indicating whether the business supplier is providing at least one of the following: a product and a service.

7. The system of claim 1, wherein the logic further causes the system to provide options to the business supplier for including in the online marketplace, wherein each of the options includes as associated price.

8. A method for facilitating business to business commerce comprising:
registering a supplier account for a business supplier on an online marketplace, wherein registering the supplier account comprises receiving a catalog of items provided by the business supplier;
registering a purchaser account for a business purchaser on the online marketplace, wherein the business purchaser represents a business entity;
providing a user interface to facilitate purchase of the item by the business purchaser from the business supplier;
receiving an indication from the business purchaser of a purchase of the item; and
facilitating exchange of the item for a predetermined price between the business purchaser and the business supplier.

9. The method of claim 8, wherein the item comprises at least one of the following: a product and a service.

10. The method of claim 8, further comprising providing a messaging option to facilitate a message between the business purchaser and the business supplier.

11. The method of claim 10, wherein the messaging option comprises an option for performing at least one of the following: a direct message from the business purchaser, a direct message from the business purchaser to a purchasing department, and a request for proposal from the business purchaser to the business supplier.

12. The method of claim 8, further comprising providing analytic information regarding the item.

13. The method of claim 8, further comprising providing an option for indicating whether the business supplier is providing at least one of the following: a product and a service.

14. The method of claim 8, further comprising providing options to the business supplier for including in the online marketplace, wherein each of the options includes as associated price.

15. A non-transitory computer-readable medium for facilitating business to business commerce that stores logic that, when executed by a computing device, causes the computing device to perform at least the following:
register a purchaser account for a business purchaser on an online marketplace, the online marketplace comprises a catalog of items, wherein the business purchaser represents a business entity;
provide the catalog of items to the business purchaser;
receive a search term from the business purchaser of an item;
perform a first search for the item on the online marketplace;
perform a second search for the item on a network that is external to the online marketplace; and
facilitate exchange of the item, based on the first search and the second search.

16. The non-transitory computer-readable medium of claim 15, wherein the item comprises at least one of the following: a product and a service.

17. The non-transitory computer-readable medium of claim 15, wherein the logic further causes the computing device to provide a messaging option to facilitate a message between the business purchaser and a business supplier and wherein the messaging option comprises an option for performing at least one of the following: a direct message from the business purchaser, a direct message from the business purchaser to a purchasing department, and a request for proposal from the business purchaser to the business supplier.

18. The non-transitory computer-readable medium of claim 15, wherein the logic further causes the computing device to perform at least the following:
determine whether the item is offered for a lower price external to the online marketplace than in the online marketplace; and
in response to determining that the item is offered for a lower price external to the online marketplace, facilitating exchange of the item for the lower price.

19. The non-transitory computer-readable medium of claim 15, wherein the second search is performed in response to a determination of at least one of the following:
the item not being provided in the online marketplace;
the item being provided in the online marketplace at a price that is higher than a predetermined threshold;
a country associated with the business purchaser; and
a country associated with the item.

20. The non-transitory computer-readable medium of claim 15, wherein the logic further causes the computing device to provide options to a business supplier for including in the online marketplace, wherein each of the options includes as associated price.
